(19) United States
(12) Patent Application Publication
(10) Pub. No.: US 2021/0132457 A1
(43) Pub. Date: May 6, 2021

(54) METHOD AND APPARATUS FOR ENHANCING RETENTION TIME OF BLEACHED AND COLORED STATES OF ELECTROCHROMIC DEVICES

(71) Applicant: SDK New Materials, Inc., Santa Clara, CA (US)

(72) Inventors: Wenming Li, Milpitas, CA (US); Jing Peng, Santa Clara, CA (US); Yue Wu, San Jose, CA (US); Jin Chuang, Taicang City (CN); Qiujun Pan, Redwood City, CA (US)

(21) Appl. No.: 17/086,451

(22) Filed: Nov. 1, 2020

Related U.S. Application Data
(60) Provisional application No. 62/929,719, filed on Nov. 1, 2019.

(51) Int. Cl. G02F 1/153; G02F 1/1523

(52) U.S. Cl. CPC G02F 1/1533; G02F 2001/1536; G02F 1/1525

(57) ABSTRACT

A method to enhance retention times for electrochromic devices. In one embodiment, an electrochromic device described herein is formed having a multilayered electrolyte layer, rather than a single layer normally used in prior art electrochromic devices. The use of a multi-layered electrolyte layer helps minimize the deleterious effects of pinholes and other defects in the electrolyte layer and significantly improve the retention time for colored and/or bleached states in such electrochromic devices.

### BACKGROUND

### I. Reference To Related Applications

This application claims the benefit of U.S. patent application Ser. No. 62/929,719 filed on Nov. 1, 2019, which is incorporated herein by reference in its entirety.

### II. Field of Use

Embodiments of the present invention relate to the field of electrochromic (EC) devices and associated fabrication process. More specifically, it relates to a novel, multilayer electrolyte to eliminate physical defects in an electrolyte and significantly improves the retention time for colored and/or bleached states in a thin film EC device.

### III. Description of the Related Art

Electrochromic (EC) devices change light transmission properties in response to voltage and thus allow control over the amount of light and heat passing through. Such EC devices may generally be referred to as bi-stable devices, providing a dark “colored” state or a transparent “bleached” state as a voltage is applied, depending on the type of electrolyte used. For example, if a voltage is applied to a cathodic EC device, it will change from a bleached state to a colored state, and will keep that state for a very long time, such as several days. Applications of EC devices include “smart glass” which changes from clear to colored as a voltages are applied to. Such smart glass has been used in applications such as office buildings and commercial aircraft, such as Boeing's 787 class of aircraft that replace pull-down window shades traditionally used by the airline industry. NASA is exploring the use of EC technology to manage thermal environments inside their newest spacecraft.

A typical, prior art EC device is shown in FIG. 1, comprising two active layers separated by an electrolyte layer through which selected mobile ions controllably move from one of the active layers to the other, back and forth. Both of the active layers may contain varying concentrations of mobile ions, such as lithium, sodium, potassium, hydrogen, or others. Among them lithium ions are commonly adopted. Lithium ions move from one active layer, namely an electrochromic (EC) layer to the other active layer, namely an ion storage layer (IS), through an electrically insulating ion-conductive layer (IC), otherwise referred to herein as an ionized electrolyte layer, or more generally, an electrolyte layer. With an applied external electrical field across the EC and IS layers, ions move from the EC layer to the IS layer (or vice-versa) and the EC device changes from a colored state to a bleached state (or vice-versa). The amount of voltage controls the amount of light and heat that may pass through the device. Thus, EC technology is especially well-suited for applications such as smart windows, electrochromic mirrors, and electrochromic display devices. A burst of electricity is typically required for changing the opacity of an EC device, but once it has changed state, generally no electricity is needed to maintain the particular state, either colored or bleached. Darkening typically occurs from the edges of the device, moving inward, and is generally a slow process, ranging from many seconds to several minutes depending on the size of the device. In some cases, electrochromic glass provides visibility even in the colored state and thus preserves visible contact with the outside environment, for example, in rearview mirrors. Electrochromic technology also finds uses in indoor applications, for example, for protection of museum objects and paintings from the damaging effects of the UV and visible wavelengths of artificial light. In these cases, EC technology can be used in conjunction with glass display cases and picture frame glass to control the amount of damaging light that reaches objects and paintings.

The IC layer in an EC device plays a very important role in determining its response time (i.e., how fast each state is achieved after application of a voltage), state retention time (the time that the device maintains a particular state after voltage has been removed), power consumption (how much voltage or power must be applied to a device in order to achieve a particular state), and device lifetime. The IC layer typically comprises a layer of ion-conductive electrolytical material, such as LiAlF4, LiF, LLZO, LiPON etc. This layer may contain defects, such as pinholes, micro-cracks, etc., caused during thin film deposition, for example, magnetron sputtering, thermal evaporation, e-beam, etc. For example, Lithium aluminum fluoride (LiAlF4) has reasonably good ion conductivity and transparency for use as an electrolyte layer in an EC device. However, during fabrication of an LiAlF4 layer, typically using thermal evaporation or sputtering techniques, physical defects such as pinholes and microcracks are frequently observed in this layer, which may cause shorting between the EC layer and the IS layer. As a result, neither the bleached state nor the colored state can be maintained for long time periods, depending on the degree of shorting, because electrons “leak” from the EC layer to the IS layer (and vice-versa) via these physical defects.

Shorts also increase the power required to operate EC devices and may decrease their lifetime expectancy. In order to prevent shorting, a relatively thick IC layer, for example more than several hundred nanometers, is sometimes used. But a thick IC layer is generally not practicable, since it increases EC device fabrication time, which in turn increases manufacturing costs, and additionally may increase an EC device response time, i.e. a time needed to transition from one state to the other.

### SUMMARY

The embodiments herein describe a number of improved electrochromic devices and methods for manufacturing such devices. In one embodiment, an improved electrochromic device comprises a substrate, a first layer of transparent conducting oxide deposited onto the substrate, an ion storage layer deposited onto the layer of transparent conducting oxide, a multi-layered electrolyte deposited onto the ion storage layer, an electrochromic layer deposited onto the multi-layered electrolyte, and a second layer of transparent conducting oxide deposited onto the substrate.

In another embodiment, a method for manufacturing one embodiment of an improved electrochromic device comprises depositing a first transparent conducting electrode onto a substrate, depositing an ion storage layer over the first transparent conducting electrode, depositing a multi-layered electrolyte over the ion storage layer, depositing an electrochromic layer over the multi-layered electrolyte, and depositing a second transparent conducting oxide over the electrochromic layer.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a microscopic side view of a prior art electrochromic device;

FIG. 2 is a microscopic side view of one embodiment of an improved electrochromic device in accordance with the principles described herein;

FIG. 3 illustrates a close up, microscopic side view of some of the layers as shown in FIG. 2, with a physical defect filled by a transparent dielectric material;

FIG. 4 is a microscopic side view of another embodiment of an improved electrochromic device in accordance with the principles described herein;

FIG. 5 is a microscopic side view of yet another embodiment of an improved electrochromic device in accordance with the principles described herein; and

FIG. 6 is a microscopic side view of yet still another embodiment of an improved electrochromic device in accordance with the principles described herein; and

FIG. 7 is a flow diagrams illustrating a method for forming one or more of the improved electrochromic devices as shown in FIGS. 2, 4 and 5, in accordance the inventive principles described herein.

### DETAILED DESCRIPTION

Methods and apparatus are described for an improved electrochromic device that offers higher retention times in a bleached and/or colored state, reduced power consumption, longer device lifetime. decreased state transition response times, and reduced manufacturing times and costs. In one embodiment, this is achieved by replacing an electrolyte layer of a prior art electrochromic device with a multi-layered structure having some combination of one or more transparent dielectric layers and one or more electrolyte layers. In another embodiment, a single electrolyte layer is used, comprising a combination of one or more transparent dielectric materials and one or more electrolyte materials. As transparent dielectric material is deposited onto an electrolyte layer, it fills in pinholes and other physical defects formed when the electrolyte layer is formed. By filling in these pinholes and other physical defects, shorting between an ion storage layer and an electrochromic layer is minimized or avoided altogether, eliminating leaks that tend to reduce retention times and increase transition times.

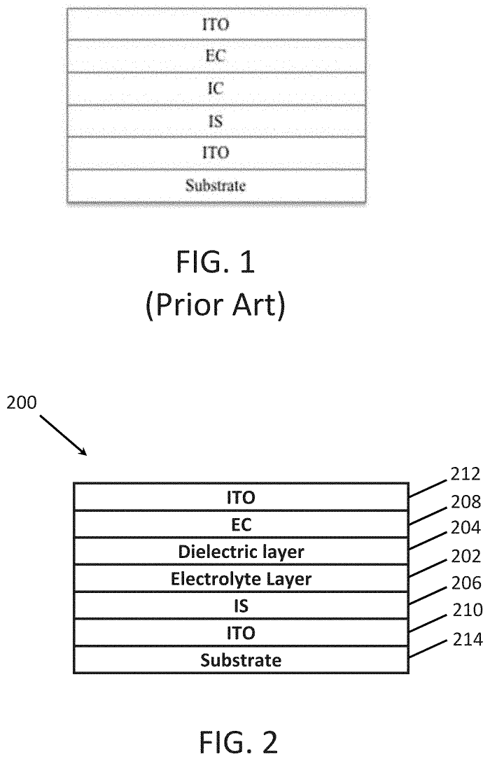

FIG. 2 is a microscopic, side view of one embodiment of an improved electrochromic device 200 in accordance with the principles described herein. In this embodiment, electrolyte layer 202 and dielectric layer 204 together form a multi-layer electrolyte, replacing the single EC layer used in prior art electrochromic devices, as shown in FIG. 1. It should be understood that the order in which lithiated electrolyte layer 202 and transparent dielectric layer 204 may be swapped, i.e., transparent dielectric layer 204 may be deposited onto ion storage (IS) layer 206 and then lithiated electrolyte layer 202 deposited over transparent dielectric layer 204. It should also be understood that the thickness of each of the layers is not to scale in FIG. 2, either in the aggregate or the layers themselves with respect to each other. For example, transparent dielectric layer 204 may comprise a thickness of 5 nm while 502 may comprise a thickness of 200 nm.

Electrolyte layer 202 comprises an ionized electrolyte, such as one of a number of lithium-based, or “lithiated” electrolytes, i.e., LiAlF4, LiF, LLZO, or LiPON, one of a number of sodium-based electrolytes, one of a number of potassium-based electrolytes, or one of a number of hydrogen-based electrolytes. As used herein, “lithiated” shall mean any electrolyte that has been ionized with either lithium, potassium, sodium or hydrogen. Dielectric layer 204 comprises a dielectric material, typically transparent or nearly-transparent in nature, such as MgF2, SiO2, Al2O3. SiNx, or others, that passes ions but restricts or prevents movement of electrons therethrough.

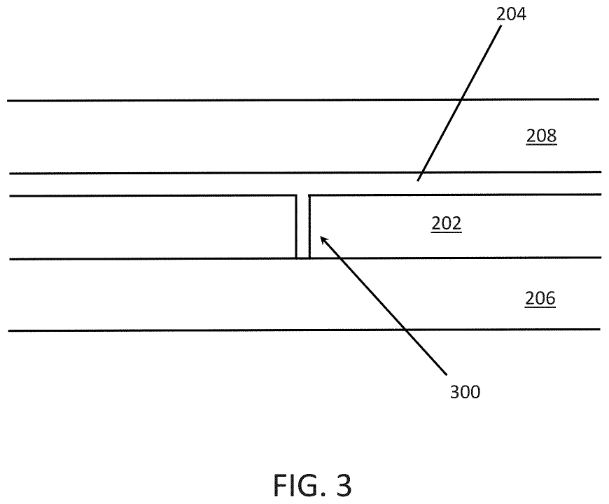

During manufacturing, electrolyte layer 202 is generally deposited first, either onto IS layer 206 or onto electrochromic (EC) layer 208, using known deposit techniques, such as magnetron sputtering, thermal evaporation, e-beam deposition, etc. The thickness of electrolyte layer 202 is typically about between 10 nm and 500 nm. Physical defects in electrolyte layer 202 may be inadvertently created during the deposition process, such as the formation of pinholes, micro-cracks and other physical defects that would normally allow leakage of electrons from IS layer 206 to electrochromic (EC) layer 208 to occur (and vice-versa). However, when dielectric layer 204 is deposited onto electrolyte layer 202, the material of dielectric layer 204 fills the physical defects and prevents electron leakage. FIG. 3 illustrates this point, showing a close up, side view of some of the layers as shown in FIG. 2, with physical defect 300, in this case a pinhole, filled by the material of dielectric layer 204. Dielectric layer 204 typically comprises a thickness of about between 2 nm-10 nm. Dielectric layer 204, then, may be referred to herein as “ultra-thin”. Dielectric layer 204 is typically deposited onto lithiated electrolyte layer 202 using well-known deposition techniques, such as a reactive Ar/O₂ high power impulse magnetron sputtering process, where an O2 partial pressure O2/(Ar+O2) is generally greater than about 30%. In another embodiment, transparent dielectric layer 204 is deposited onto lithiated electrolyte layer 202 using a relatively low deposition pressure of about between 2 mTorr and 10 mTorr, with a relatively low deposition rate to form a continuous thin film.

During operation, a voltage is applied across ITO conductive layer 210 and ITO conductive layer 212. In one embodiment, ITO conductive layer 210 and ITO conductive layer 212 each comprise a transparent, electrically-conductive material, such as indium tin oxide. In other embodiments one of the conductive layers comprises a transparent, electrically-conductive material while the other conductive layer comprises a reflective conducting material, such as aluminum, gold or silver, which controls an intensity of light reflected from this layer. This embodiment is useful in applications such as rear-view mirrors for cars and electrochromic display devices.

When a voltage is applied across ITO conductive layer 210 and ITO conductive layer 212, typically about 1 volt to about 50 volts depending on a size of the devices, electrolyte layer 202 allows movable ions from IS layer 206 to move through electrolyte layer 202 and dielectric layer 204 to EC layer 208, thus causing EC layer 208 to become colored, in an embodiment where EC layer 208 comprises a cathodic oxide such as WO3, V2O5, TiO2, Nb2O5, etc. (or bleached, in an embodiment where EC layer 208 comprises an anodic oxide, such as NiO, IrOx, etc.). This colored (or bleached) state may be maintained for long periods of time, such as days, weeks or even months and years, even when the voltage is removed, in part, due to dielectric layer 204 preventing electron leakage between IS layer 206 and EC layer 208.

When the voltage is reversed, electrolyte layer 202 allows the mobile ions in EC layer 208 to migrate to IS layer 206 (or vice-versa), through electrolyte layer 202 and dielectric layer 204, thus causing IS layer 206 to become bleached, in an embodiment where IC layer 208 comprises a cathodic oxide, or become colored, in an embodiment where IC layer 208 comprises an anodic oxide. Again, this state may be maintained for long periods of time, such as days, weeks or even months and years, even when the voltage is removed.

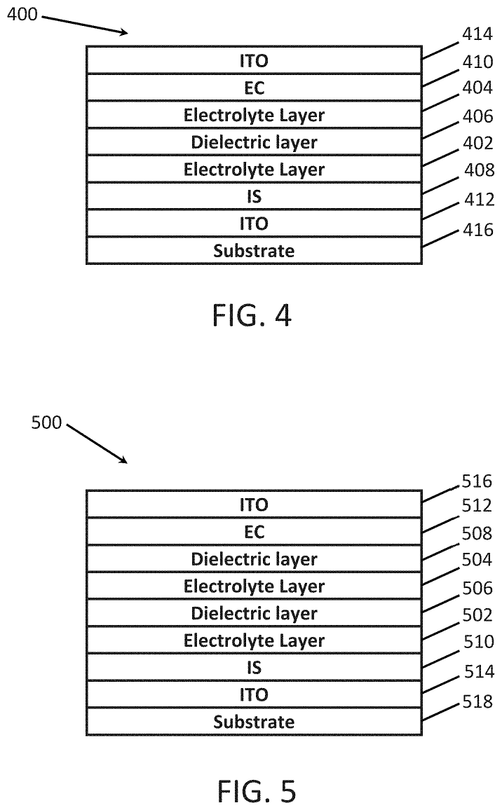

FIG. 4 is a microscopic, side view of another embodiment of an improved electrochromic device 400 in accordance with the principles described herein. In this embodiment, electrolyte layer 402, dielectric layer 406 and electrolyte layer 404 together form a multi-layer electrolyte, replacing the single EC layer used in prior art electrochromic devices, as shown in FIG. 1. As in FIG. 2, the thickness of each of the layers shown in FIG. 4 may not be to scale, either in the aggregate or the layers themselves with respect to each other. Layers IS 408, EC 410, ITO 412, ITO 414, and substrate 416 are the same or similar to layers IS 206, EC 208, ITO 210, no 212, and substrate 214, respectively, as shown in FIG. 2, Electrolyte layers 402 and 404 are the same or similar as electrolyte layer 202 as shown in FIG. 2, while dielectric layer 406 is the same or similar to dielectric layer 204 as shown in FIG. 2. In one embodiment, each of electrolyte layer 402 and 404 are made of the same electrolytic material, while in another embodiment, electrolyte layer 402 is made of a different electrolytic material than the material used for electrolyte layer 404.

During manufacturing, electrolyte layer 402 is deposited onto IS layer 408, typically using known deposit techniques, such as magnetron sputtering, thermal evaporation, e-beam deposition, etc., and typically is about between 10 nm and 500 nm thick. As described before, physical defects may be inadvertently introduced into electrolyte layer 402 during the deposition process over IS layer 408. These defects may be reduced or eliminated by depositing dielectric layer 406 onto electrolyte layer 402, thereby filling the physical defects and preventing electron leakage. Next, electrolyte layer 404 is deposited onto dielectric layer 406, using the same magnetron sputtering, thermal evaporation, e-beam deposition as electrolyte layer 402. While physical defects may be created during this process, electrons cannot pass between EC layer 410 and IS layer 408 because of the presence of dielectric layer 406.

During operation, a voltage is applied across conductive layer ITO 412 and ITO 414. The mobile ions in IS layer 408 are then able to migrate to EC layer 410 (or vice-versa), through electrolyte layer 402, dielectric layer 406 and electrolyte layer 404, thus causing EC layer 410 to become bleached, in an embodiment where EC layer 410 comprises a cathodic oxide, or become colored, in an embodiment where EC layer 410 comprises an anodic oxide. Again, this state may be maintained for long periods of time, such as days, weeks or even months and years, even when the voltage is removed.

FIG. 5 is a microscopic, side view of yet another embodiment of an improved electrochromic device 500 in accordance with the principles described herein. In this embodiment, electrolyte layer 502, dielectric layer 506, second electrolyte layer 504 and second dielectric layer 508 together form a multi-layer electrolyte, replacing the single EC layer used in prior art electrochromic devices, as shown in FIG. 1. As in FIGS. 2 and 4, the thickness of each of the layers shown in FIG. 5 may not be to scale, either in the aggregate or the layers themselves with respect to each other. Layers IS 510, EC 512, ITO 514, ITO 516, and substrate 418 are the same or similar to layers IS 206/408, EC 208/410, ITO 210/412, ITO 212/414, and substrate 214/416, respectively, as shown in FIGS. 2 and 4. Electrolyte layers 502 and 504 are the same or similar as electrolyte layer 202/402/404 as shown in FIGS. 2 and 4 while dielectric layers 506 and 508 are the same or similar to dielectric layer(s) 204/406 as shown in FIGS. 2 and 4. In one embodiment, each of electrolyte layers 502 and 504 are made of the same electrolytic material, while in another embodiment, electrolyte layer 502 is made of a different electrolytic material than the material used for electrolyte layer 504. Similarly, dielectric layer 506 could be made from the same material as dielectric layer 508 or the materials could be different from each other. Finally, it should be understood that the layers shown in the multi-layer electrolyte layer represented by electrolyte layer 502, electrolyte layer 504, dielectric layer 506 and dielectric layer 508 could ordered differently, i.e., a transparent dielectric layer could be deposited on IS layer 510, followed by an electrolyte layer, followed by another transparent dielectric layer, followed by another electrolyte layer, followed by EC 512.

The multi-layer electrolyte structure shown in FIG. 5 can be viewed as a repeating pattern of an electrolytic layer and a dielectric layer. With reference to the multi-layer electrolytic structure shown in FIG. 2 (i.e., electrolyte layer 202 and dielectric layer 204), this represents a repeat pattern of 1 (i.e., electrolyte layer 202 and dielectric layer 204 are repeated a number of 1 times), while the multi-layer electrolytic electrolyte shown in FIG. 5 (i.e., electrolytic layer 502, electrolytic layer 504, dielectric layer 506 and dielectric layer 508) represents a repeat pattern of 2. In other embodiments, an electrochromic device may comprise 3 or more of such repeating patters of alternating electrolytic layers and dielectric layers. The purpose of using multiple pairs of electrolyte/dielectric layers is to form a particular microstructure that disrupts pinholes and other physical defects caused as the electrolyte typically crystalizes to form “columns”, separated from each other by “grain boundaries”. Another way that pinholes and other physical defects are formed is by what is known as the “shadow effect”, where columns of crystalizing electrolyte block further deposition of electrolyte material between the columns. Defects caused by the aforementioned microstructure typically grow continuously throughout the thin film during crystallization, causing thin film underperformance or even failure. These defects typically grow in proportion to the thickness of the electrolyte material. By using a dielectric material as part of a multilayered structure to form the electrolyte layer, an artificial boundary is introduced that interrupts progression of defects. In effect, the dielectric causes the electrolyte layer to form a superlattice-like structure, i.e., meaning that the column structure normally formed during electrolyte deposition is interrupted by the dielectric, forming a fine, smooth boundary void of defects. This dielectric boundary blocks and traps electrons in the electrolyte material, preventing them from causing a short in an electrochromic device.

The layers shown in FIG. 5 are manufactured in the same way as described earlier herein.

During operation, a voltage is applied across conductive ITO layer 514 and ITO layer 516.

The mobile ions in IS layer 510 then migrate to EC layer 512 (or vice-versa), through electrolyte layer 502, dielectric layer 506, electrolyte layer 504 and dielectric layer 508, thus causing EC layer 512 to become bleached, in an embodiment where EC layer 512 comprises a cathodic oxide, or become colored, in an embodiment where EC layer 512 comprises an anodic oxide. This state may be maintained for even longer periods of time than the structures of FIGS. 2 and 4, because two transparent dielectric layers are used, offering about twice the protection as that of FIGS. 2 and 4 against electron leakage.

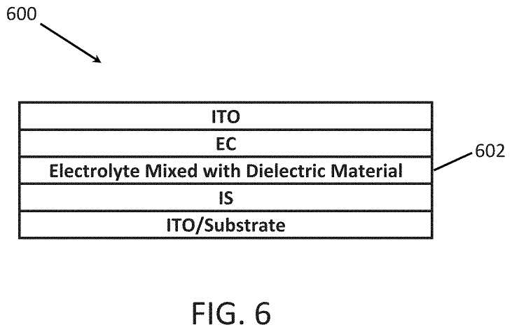

FIG. 6 is a microscopic, side view of yet still another embodiment of an improved electrochromic device 600 in accordance with the principles described herein. In this embodiment, a single, mixed electrolyte layer 602 comprises a composition of electrolyte material and dielectric material. Prior art electrolyte layers have typically comprises a homogeneous electrolyte, with no dielectric material used. It should be understood that the thickness of each of the layers shown in FIG. 6 is not to scale, either in the aggregate or the layers themselves with respect to each other.

In one embodiment, a ratio of electrolyte and dielectric is chosen. These are then heated to a liquid and mixed together, then allowed to cool. As cooling occurs, dielectric molecules move to fill in any pin holes or other physical deformities in the electrolyte. In another embodiment, the electrolyte and the dielectric are applied to an IS layer or EC layer by “co-sputtering”, i.e., using well-known sputtering techniques, disbursing both materials at the same time. This forms a mixture of the two materials having different atomic radii sizes. During deposition, small molecules will move to fill pin holes or other defects and form a dense, thin film. In either embodiment, the mixed electrolyte layer 602 will block electrons effectively in order to increase the retention time of device 600.

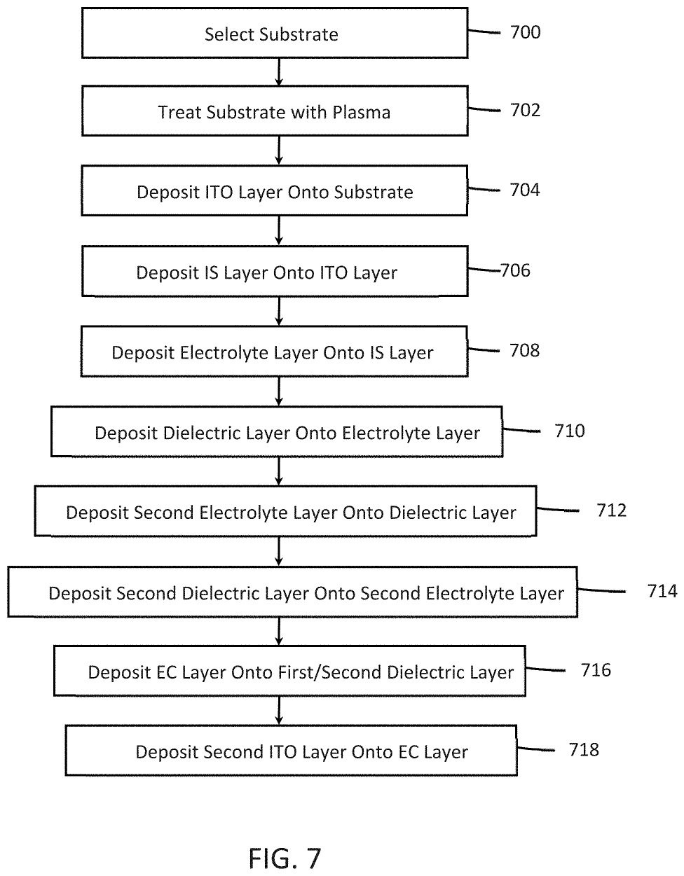

FIG. 7 is a flow diagrams illustrating a method for forming one or more of the improved electrochromic devices as shown in FIGS. 2, 4 and 5, in accordance the inventive principles described herein. Reference is made to FIG. 2, in an embodiment where a multi-layer electrolyte comprises an electrolyte layer and a dielectric layer, to FIG. 4, in an embodiment where a multi-layer electrolyte comprises an electrolyte layer, a dielectric layer and a second electrolyte layer, and to FIG. 5, in an embodiment where a multi-layer electrolyte comprises an electrolyte layer, a dielectric layer, a second electrolyte layer and a second dielectric area. It should be understood that in some embodiments, not all of the steps shown in FIG. 7 are performed and that the order in which the steps are carried out may be different in other embodiments. It should be further understood that some minor method steps have been omitted for purposes of clarity.

At block 700, substrate 214/416/518 is selected based on an application of an electrochromic device. Typically, substrate 214/416/518 comprises glass, plastic or some other firm or semi-rigid, transparent material and generally ranges between about 1/16 inch and 1 inch in thickness.

At block 702, substrate 214/416/518 may be plasma treated in preparation deposition of ITO layer 210/412/514, using techniques well-known in the art

At block 704, ITO layer 210/412/514 is deposited onto substrate 214, using thin film techniques well known in the art. In one embodiment, ITO layer 210/412/514 comprises a transparent, electrically-conductive material, such as indium tin oxide. In other embodiments ITO layer 210/412/514 comprises a reflective conducting material, such as aluminum, gold or silver, which controls an intensity of light reflected from this layer. This embodiment is useful in applications such as rear-view mirrors for cars and electrochromic display devices.

At block 706, ion storage (IS) layer 206/408/510 is deposited onto ITO layer 210/412/514, using thin film techniques well known in the art.

At block 708, electrolyte layer 202/402/502 is deposited over IS layer 206. Electrolyte layer 202/402/502 comprises an ionized electrolyte, such as one of a number of lithium-based, or “lithiated” electrolytes, i.e., LiAlF4, LiF, LLZO, or LiPON, one of a number of sodium-based electrolytes, one of a number of potassium-based electrolytes, or one of a number of hydrogen-based electrolytes. Deposition is achieved using well known thin film techniques, such as such as magnetron sputtering, thermal evaporation, e-beam deposition, etc., typically comprising a thickness of about between 10 nm and 500 nm.

At block 710, dielectric layer 204/406/504 is deposited over electrolyte layer 202 using well-known deposition techniques, such as using a reactive Ar/O2 high power impulse magnetron sputtering process, where an O2 partial pressure O2/(Ar+O2) is generally greater than about 30%. In another embodiment, transparent dielectric layer 204/406/504 is deposited onto electrolyte layer 202/402/502 using a relatively low deposition pressure of about between 2 mTorr and 10 mTorr, with a relatively low deposition rate to form an ultra-thin, continuous thin film between about 2 nm and 10 nm thick. Dielectric layer 204/406/504 fills any pinholes or other physical defects in electrolyte layer 202/402/502 such that it forms an effective barrier against electrons that try to migrate between IS layer 206/408/510 and EC layer 208/408/512.

At block 712, in the embodiment described with respect to FIG. 4, a second electrolyte layer 404/504 is deposited onto dielectric layer 406/506, using the same techniques as described above. Use of a second electrolyte layer 404/504 allows each electrolyte layer 402/502 and electrolyte layer 404/504 to be half as thick as a single electrolyte layer of equal overall thickness. Generally, formation of pinholes and other physical defects is reduced by using two or more electrolyte layers, because as the thickness of an electrolyte layer is reduced, factors such as the “column” effect and the “shading” effect, described earlier, become less pronounced.

At block 714, in the embodiment described with respect to FIG. 5, a second dielectric layer 508 is deposited onto the second electrolyte layer 504, using the same thin film techniques as described above. This creates a multi-layered electrolyte structure that repeats the multi-layered electrolyte structure shown in FIG. 1 by a repetition factor of 2. In other embodiments, three or more of the multi-layered electrolyte structures shown in FIG. 1 can be stacked together to form a multi-layered electrolyte structure. The advantage of using multiple “stackings” is that the thickness of each electrolyte layer can be reduced by the repetition factor. For example, if an overall electrolyte thickness of 300 nm is desired, rather than fabricate a single electrolyte layer of 300 nm, three electrolyte layers are formed, each separated by an ultra-thin dielectric layer, where each of the three electrolyte layers are only 100 nm thick. In this way, pinholes and other physical defects may be reduced because, in general, fewer pinholes and other physical defects are formed is the thickness of an electrolyte layer is reduced.

At block 716, EC layer 208/410/512 is deposited onto either transparent dielectric layer 204, 404 or 508, depending on which embodiment is being fabricated, using well known thin film techniques. EC layer 208/410/512 comprises either a cathodic oxide such as WO3, V2O5, TiO2, Nb2O5, etc. that becomes colored when a voltage is applied between ITO layers 210/412/514 and ITO layers 212/414/516, or an anodic oxide such as NiO, IrOx, etc. that becomes bleached when a voltage is applied to a pair of ITO layers of the electrochromic device.

At block 718, a second ITO layer 212/414/516 is deposited onto EC layer 208/410/516, using thin film techniques well known in the art. Second ITO layer 212/414/516 comprises a transparent, electrically-conductive material, such as indium tin oxide. Typically, ITO layer 212/414/516 comprises the same material as ITO layer 210/412/514, but in other embodiments, may be different.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein may need not be performed in any particular order. Furthermore, although elements of the invention may be described or claimed in the singular, the plural is contemplated unless limitation to the singular is explicitly stated.

We claim:

1. An improved electrochromic device, comprising:
a substrate;
a first layer of transparent conducting oxide deposited onto the substrate;
an ion storage layer deposited onto the layer of transparent conducting oxide;
a multi-layered electrolyte deposited onto the ion storage layer;
an electrochromic layer deposited onto the multi-layered electrolyte; and
a second layer of transparent conducting oxide deposited onto the substrate.

2. The electrochromic device of claim 1, wherein the multi-layered electrolyte comprises:
a lithiated electrolyte layer; and
a dielectric layer deposited onto the dielectric layer.

3. The electrochromic device of claim 2, wherein material from the dielectric layer fills any physical defects created as a result of forming the lithiated electrolyte layer.

4. The electrochromic device of claim 2, wherein the dielectric layer is selected from the group consisting of Al2O3, SiO2, Si3N4, HfO, ZnO, and TiO2.

5. The electrochromic device of claim 2, wherein the transparent dielectric layer comprises a thickness of about between 2 nm and 10 nm.

6. The electrochromic device of claim 2, wherein the lithiated electrolyte layer is selected from the group consisting of LiAlF4, LiF, LLZO, and LiPON.

7. The electrochromic device of claim 2, wherein the lithiated electrolyte layer comprises a thickness of about between 10 nm and 500 nm.

8. The electrochromic device of claim 2, wherein the lithiated electrolyte layer is deposited onto the transparent dielectric layer via a magnetron sputtering deposition process; and
the lithiated electrolyte layer is deposited onto the transparent dielectric layer under a pressure between about 10 mTorr and 50 mTorr.

9. The electrochromic device of claim 2, further comprising:
a second lithiated electrolyte layer;
wherein the transparent dielectric layer is sandwiched between the lithiated electrolyte layer and the second lithiated electrolyte layer.

10. The electrochromic device of claim 1, wherein the multi-layered electrolyte comprises:
a transparent dielectric layer;
a lithiated electrolyte layer deposited onto the transparent dielectric layer;
a second transparent dielectric layer deposited onto the lithated electrolyte layer; and
a second lithated electrolyte layer deposited onto the second transparent dielectric layer.

11. A method for constructing an electrochromic device, comprising:
depositing a first transparent conducting electrode onto a substrate;
depositing an ion storage layer over the first transparent conducting electrode;
depositing a multi-layered electrolyte over the ion storage layer;
depositing an electrochromic layer over the multi-layered electrolyte; and
depositing a second transparent conducting oxide over the electrochromic layer.

12. The method of claim 10, wherein depositing the multi-layered electrolyte comprises:
depositing a lithiated electrolyte layer over the ion storage layer; and
depositing a transparent dielectric layer over the lithiated electrolyte layer.

13. The method of claim 12, wherein depositing the transparent dielectric layer onto the lithiated electrolyte layer fills in any physical defects created in the lithiated electrolyte layer as the transparent dielectric layer is deposited over the lithiated electrolyte layer.

14. The method of claim 12, wherein the transparent dielectric layer is selected from the group consisting of Al2O3, SiO2, Si3N4, HfO, ZnO, and TiO2.

15. The method of claim 12 wherein the transparent dielectric layer comprises a thickness of about between 2 nm and 10 nm.

16. The method of claim 12, wherein the lithiated electrolyte layer is selected from the group consisting of LiAlF4, LiF, LLZO, and LiPON.

17. The method of claim 12, wherein the lithiated electrolyte layer comprises a thickness of about between 10 nm and 500 nm.

18. The method of claim 12, wherein the lithiated electrolyte layer is deposited onto the transparent dielectric layer via a magnetron sputtering deposition process;
wherein depositing the lithiated electrolyte layer onto the transparent dielectric layer comprises depositing the lithiated electrolyte layer under a pressure between about 10 mTorr and 50 mTorr.

19. The method of claim 12, further comprising:
depositing a second lithiated electrolyte layer onto the transparent dielectric layer;
wherein the transparent dielectric layer is sandwiched between the lithiated electrolyte layer and the second lithiated electrolyte layer.

20. The method of claim 11, wherein forming the multi-layered electrolyte comprises:
depositing a lithiated electrolyte layer onto the ion storage layer;
depositing a transparent dielectric layer onto the lithated electrolyte layer;
depositing a second lithated electrolyte layer onto the transparent dielectric layer; and
depositing a second transparent dielectric layer onto the second lithated electrolyte layer;
wherein depositing the transparent dielectric layer onto the lithiated electrolyte layer fills in any physical defects created by depositing the lithiated electrolyte layer onto the ion storage layer, and depositing the second transparent dielectric layer onto the second lithiated electrolyte layer fills in any physical defects created by depositing the second lithiated electrolyte layer onto the transparent dielectric layer.
